(19) United States
(12) Patent Application Publication
(10) Pub. No.: US 2025/0049542 A1
(43) Pub. Date: Feb. 13, 2025

(54) Straight Zygoma and Angled Multi-Unit Abutment Implant

(71) Applicant: Dan ROSEN, Calabasas, CA (US)

(72) Inventor: Dan ROSEN, Calabasas, CA (US)

(21) Appl. No.: 18/233,299

(22) Filed: Aug. 12, 2023

(51) Int. Cl. A61C 8/00

(52) U.S. Cl. CPC A61C 8/0068; A61C 8/0053; A61C 8/0069

(57) ABSTRACT

A multi-unit abutment apparatus for prosthetic teeth includes an implant screw having a first threaded portion for engaging and anchoring in the osseous bone. An elongated extension portion has a conical bottom portion for engaging the implant screw and having a socketed top. An abutment portion has an anti-rotation portion configured to engage the socketed top of the elongated extension portion in a non-rotational arrangement. The abutment portion has a body having a screw bore in axial parallel with the elongated extension portion and the implant screw and includes a mounting portion having a seat configured for seating the prosthetic tooth at between zero and sixty degrees.

### FIELD OF THE INVENTION

The present invention relates to dentistry. More specifically the invention relates to dental implants, also known as endosseous implants or fixtures. Still more specifically, the invention relates to multi-unit abutments for dental implants including zygomatic implants.

### BACKGROUND

In dentistry, an abutment is a connecting element. This is used in the context of a fixed bridge (the “abutment teeth” referring to the teeth supporting the bridge), partial removable dentures (the “abutment teeth” referring to the teeth supporting the partial) and in implants (used to attach a crown, bridge, or removable denture to the dental implant fixture). Customary implant fixtures are the screw-like component that is osseointegrated. An example abutment most commonly used with dental implants, for example, in “All-on-Four” protocols. They are designed for screw-retained group restorations which are often used in combination with angled dental implants and whole arch replacements, as well as screw fixation of bridges made of zirconium or metal-ceramic group restorations to the implant.

One problem with dental abutments as they are presently known is an inability to form a proper angle between the angle an implant screw is inserted into a patient's bone, and the angle of the prosthetic tooth. This is particularly important in the case of, for example, zygomatic implants, where there is a great distance between the zygoma, where the implant screw is anchored and the prosthetic site, which may be maxillary, or farther forward on the patient's tooth arch.

For these reasons it is an object of the present invention to provide a multi-unit abutment that allows a variety of degrees between the implant screw and prosthetic tooth. These and other objects are more fully described in the following specification and drawings.

### SUMMARY

A multi-unit abutment apparatus for placing a prosthetic tooth in the osseous bone of a dental implant patient remotely from an implant screw, includes an implant screw having a first threaded portion configured for engaging and anchoring in the osseous bone. An elongated extension portion configured with a conical bottom portion for engaging the implant screw and having a socketed top. An abutment portion having an anti-rotation portion configured to engage the socketed top of the elongated extension portion in a non-rotational arrangement.

The abutment portion also includes a body portion having a screw bore in axial parallel with the elongated extension portion and the implant screw. The abutment portion preferably includes a mounting portion having a seat configured for seating the prosthetic tooth, and a fifth threaded portion configured to accept a prosthetic screw for mounting the prosthetic tooth to the abutment portion. The fifth threaded portion is between zero and sixty degrees off-axis from the elongated extension portion.

In various embodiments the implant screw may include a first threaded portion for engaging the patient's osseous bone and a second threaded portion for engaging the extension portion. The first threaded portion is preferably opposite the second threaded portion. The second threaded portion preferably includes a non-threaded upper portion configured to engage the conical bottom portion of the extension portion. The anti-rotation portion is a hex pattern and wherein the socketed top is a complimentary hex pattern.

In other embodiments, the screw bore may comprise a reduced conical circumference corresponding to a conical portion of an abutment screw configured to engage the extension portion. The abutment portion preferably comprises a mounting portion on which the prosthetic tooth seats. The mounting portion may have a variable conical surface. In yet other embodiments, the seat may surround the variable conical surface, and the screw bore may be configured such that an abutment screw engaging the extension portion clears a prosthetic screw engaging the prosthetic tooth and fifth threaded portion.

The invention may also be characterized as a multi-unit abutment kit apparatus for placing one or more prosthetic teeth in the osseous bone of a dental implant patient remotely from one or more implant screws, the kit preferably includes a plurality of implant screws, each having a first threaded portion configured for engaging and anchoring in the osseous bone. A plurality of elongated extension portions is provided, each configured with a conical bottom portion for engaging one of the implant screws and having a socketed top. A plurality of abutment portions is provided, each having an anti-rotation portion configured to engage the socketed top of the elongated extension portion in a non-rotational arrangement.

Each of the abutment portions further comprising a body portion having a screw bore in axial parallel with the elongated extension portion and the implant screw. Each of the abutment portions further comprising a mounting portion having a seat configured for seating the prosthetic tooth, and a fifth threaded portion configured to accept a prosthetic screw for mounting the prosthetic tooth to the abutment portion, and the fifth threaded portion is between zero and sixty degrees off-axis from the elongated extension portion.

In various other embodiments, each of the implant screws includes a first threaded portion for engaging the patient's osseous bone and a second threaded portion for engaging the extension portion. Each of the first threaded portions is preferably opposite the second threaded portion. Each of the second threaded portions includes a non-threaded upper portion configured to engage the conical bottom portion of the extension portion. Each of the anti-rotation portions is a hex pattern and wherein the socketed top is a complimentary hex pattern.

In other embodiments, the screw bore comprises a reduced conical circumference corresponding to a conical portion of an abutment screw configured to engage the extension portion. Each of the abutment portions comprises a mounting portion on which the prosthetic tooth seats. The mounting portions may have a variable conical surface. The seat surrounds the variable conical surface. Preferably, the screw bore is configured such that an abutment screw engaging the extension portion clears a prosthetic screw engaging the prosthetic tooth and fifth threaded portion.

### BRIEF DESCRIPTION OF THE FIGURES

FIG. 1 illustrates an assembled dental implant and multi-unit abutment in accordance with the present invention.

FIG. 2 illustrates an exploded view of a dental implant and multi-unit abutment in accordance with the present invention.

FIG. 3 illustrates a cut-away side view of a seventeen degree angle multi-unit abutment according to the present invention with a fixing screw installed therein.

FIG. 4 illustrates a front view of the seventeen degree angle multi-unit abutment image shown in FIG. 3.

FIG. 5 illustrates a cut-away side view of a thirty degree angle multi-unit abutment according to the present invention with a fixing screw installed therein.

FIG. 6 illustrates a front view of the thirty degree angle multi-unit abutment image shown in FIG. 5.

FIG. 7 illustrates a cut-away side view of a forty-five degree angle multi-unit abutment according to the present invention with a fixing screw installed therein.

FIG. 8 illustrates a front view of the forty-five degree angle multi-unit abutment image shown in FIG. 7.

### DESCRIPTION

The present invention is described more fully hereinafter, but not all embodiments are shown. While the invention has been described with reference to exemplary embodiments, it will be understood by those skilled in the art that various changes may be made, and equivalents may be substituted for elements thereof without departing from the scope of the disclosure. In addition, many modifications may be made to adapt a particular structure or material to the teachings of the disclosure without departing from the essential scope thereof.

The drawings accompanying the application are for illustrative purposes only. They are not intended to limit the embodiments of the present application. Additionally, the drawings are not drawn to scale. Common elements between different figures may retain the same numerical designation.

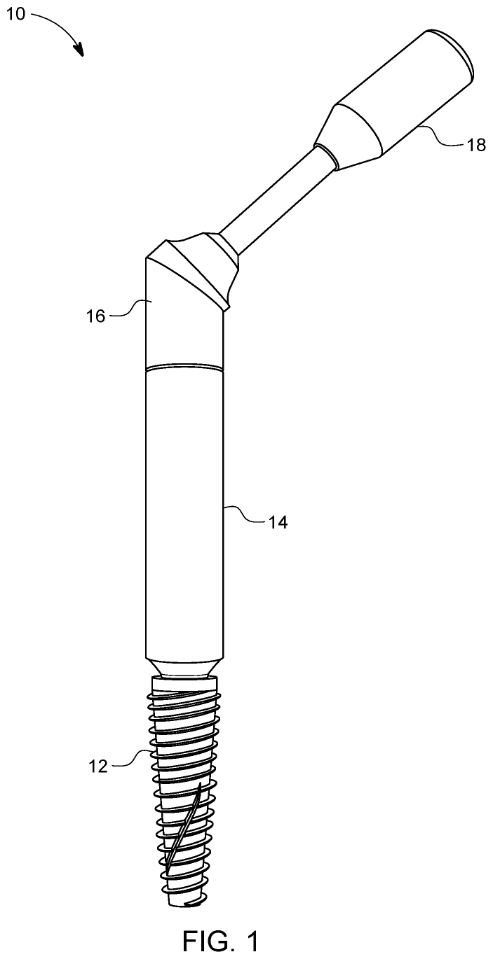

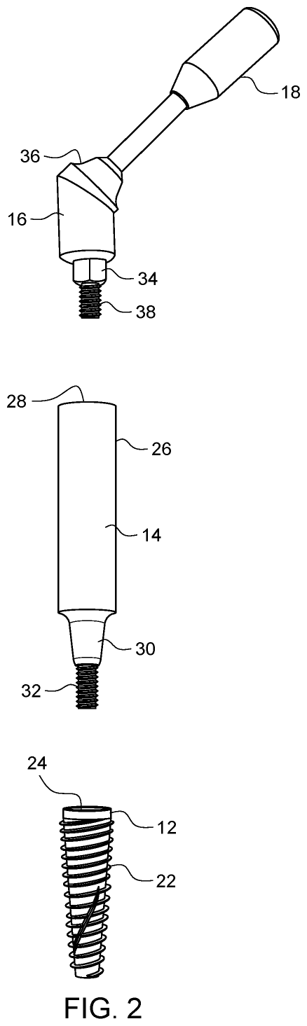

Referring to FIG. 1 a multi-unit abutment (MUA) zygoma implant 10 is shown in an assembled state, with a tightening driver 18 driven into the abutment portion 16. The MUA 10 includes an implant screw 12 which is configured to engage a patient's bone at an implant site. An elongated extension portion 14 is configured to rotate into the top of the implant screw 12 using a threaded connection, thereby affixing the extension portion 14 to the implant screw 12. The abutment portion 16 affixes to the extension portion 14 in a non-rotational arrangement, and affixes to the extension portion 14 with a multi-unit abutment screw 20 (FIG. 2).

Referring to FIG. 2, the MUA 10 is shown in exploded view. The implant screw 12 includes a first threaded portion 22 for engaging the patient's bone and a second threaded portion 24 for engaging the extension portion 14. The second threaded portion 24 includes a non-threaded upper portion (not shown) and a threaded lower portion (not shown). The extension portion 14 has a cylindrical body portion 26, a socketed top 28, and a conical bottom portion 30. The conical bottom portion 30 terminates in a third threaded portion 32. The third threaded portion 32 and the conical bottom portion 30 are configured to engage the threaded lower portion and non-threaded upper portion, respectively, of the implant screw.

Still referring to FIG. 2, the abutment portion 16 of the MUA 10 includes a hex portion 34 configured to extend into the socketed top 28. The socketed top 28 of the extension portion 14 includes a complimentary hex pattern such that when the hex portion 34 is inserted into the socketed top, the abutment portion 16 cannot rotate relative to the extension portion 14. Preferably, the socketed top may end in a conical portion for stability and full contact with the abutment portion 16. The abutment portion 16 also includes a screw bore 36 at the top of the abutment portion 16. An abutment screw 38 is installed in the screw bore 36, and travels through the abutment portion 16 until it extends out of the hex portion 34. Inward and upward of the hex portion 34, the MUA 10 is conical. This allows full contact between the abutment screw and the MUA 10.

When the hex portion 34 is installed in the socketed top 28, the abutment screw 38 is inserted into the screw bore 36 moved downward until it engages the socketed top, travelling therethrough, and tightened, thereby anchoring the abutment portion 16 to the extension portion 14. The tightening driver 18 can be used to both hold the abutment portion 16 and articulate the MUA 10 to ensure proper placement.

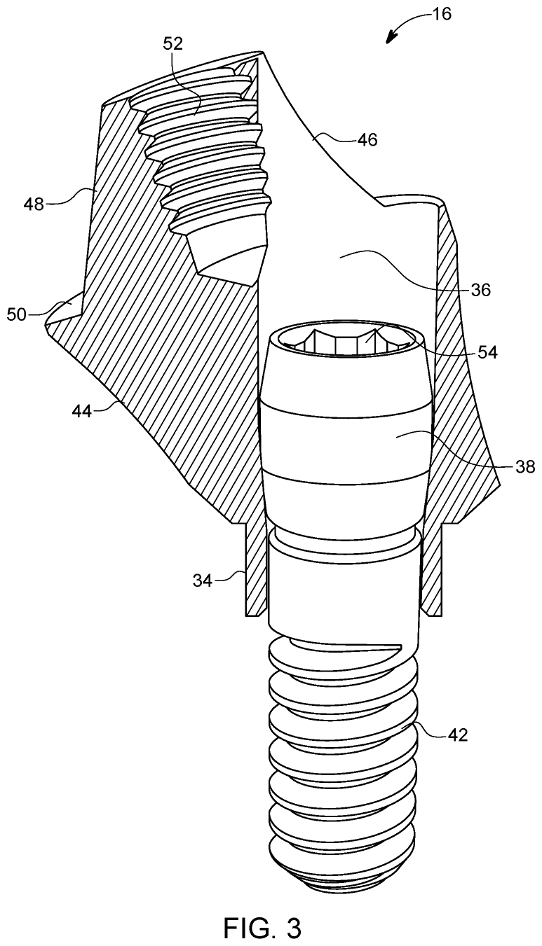

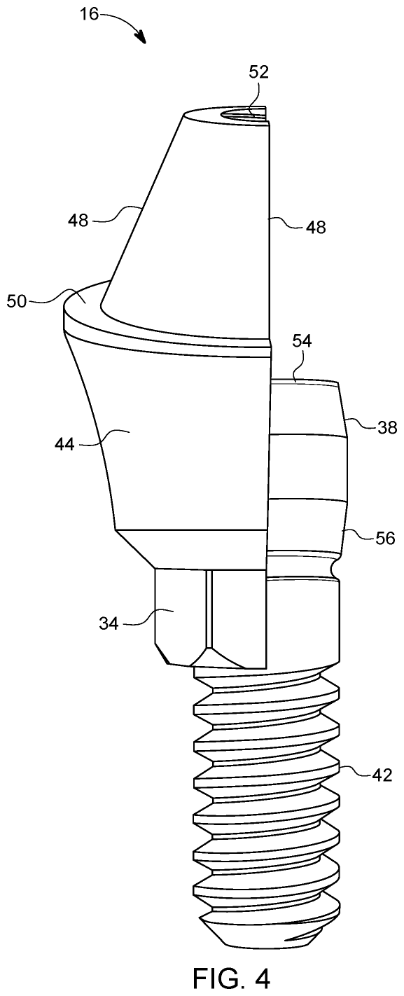

Referring to FIGS. 3 and 4, a seventeen degree angle multi-unit abutment portion 16 is shown. FIG. 3 shows a cut-away view of the abutment portion 16 and the abutment screw 38. As shown in cut-away, the screw bore 36 extends all the way through the abutment portion 16, including the hex portion 34 at the bottom of the screw bore 36. The screw bore 36 has a slightly conically reduced diameter inside the abutment portion 16, such that the abutment screw 38 seats against the screw bore 36 without being able to pass through it. The screw bore 36 is sized to anchor inside the screw bore 36 with a fourth threaded portion 42 extending below the hex portion 34. The abutment screw 38 preferably includes a hex socket 54, or similar socket for driving the abutment screw 38 through the abutment portion 16.

Still referring to FIG. 3, the abutment portion 16 includes a body portion 44, which is conical for interfacing with a user's gum line. A mounting portion 46 is also conical and is configured to form a seat area 50 for a prosthetic (not shown). The degree angle (seventeen degrees) refers to the angular difference between the axis around which the seat area 50 extends and the axis of the screw bore 36, and therefore the extension portion 14 and implant screw 12 as well. The mounting portion 46 may include a variable conical surface 48 for providing additional strength on the leading edge of the prosthetic. Preferably the mounting portion 46 and the body portion 44 may be separated by a seat area 50 against which the prosthetic rests. A fifth threaded portion 52 extends into the mounting portion to accept a prosthetic screw (not shown), which anchors the prosthetic to the abutment portion 16.

Referring to FIG. 4, the abutment portion 16 of FIG. 3 is shown rotated ninety degrees to illustrate a front view. As shown in this view, the abutment screw 38 includes a head having a conical sidewall 56 above the fourth threaded portion 42 for engaging the screw bore 36 (FIG. 3) inside the abutment portion 16. The seventeen degree angle abutment portion 16 may be useful in instances where there is a shorter distance between the area where the implant screw 12 is anchored and the implant site where the prosthetic will be.

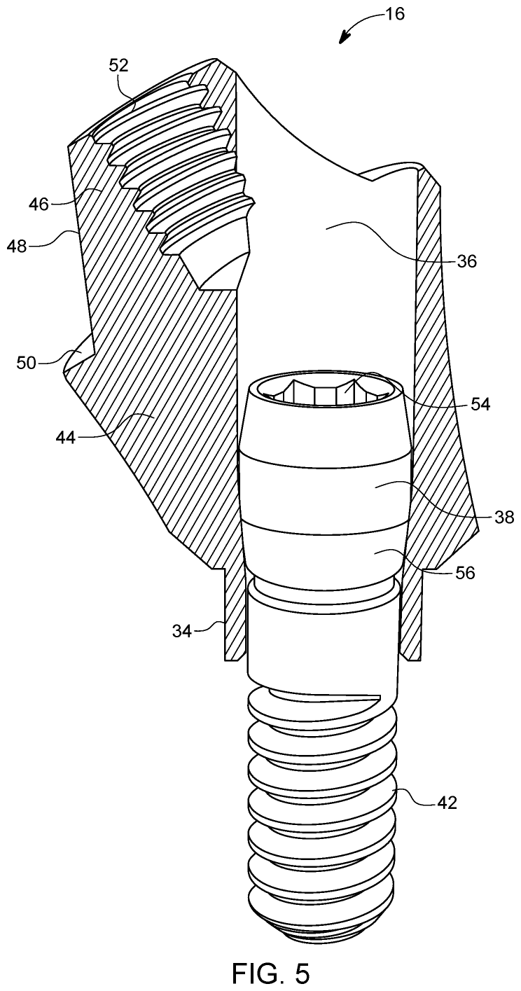

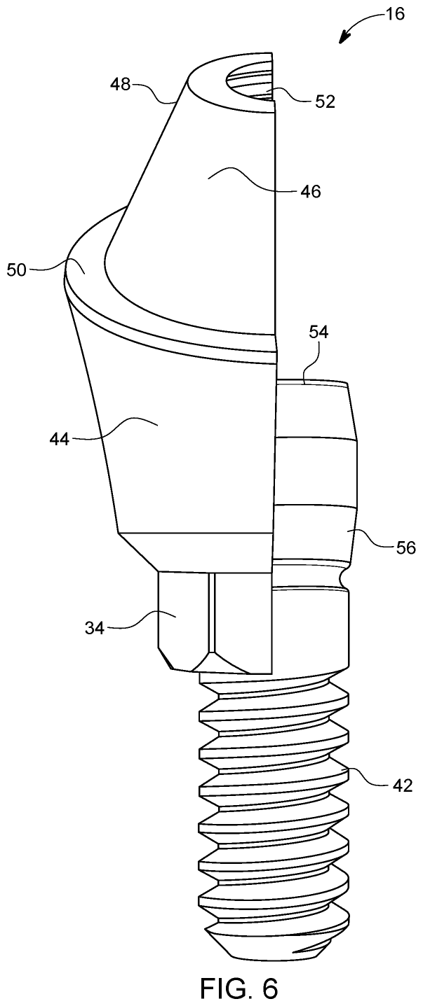

Referring to FIGS. 5 and 6, a thirty degree angle multi-unit abutment portion 16 is shown. Referring to FIG. 5, in this embodiment, the screw bore 36 is at a thirty degree angle relative to the seat area 50, variable conical surface 48, and fifth threaded portion 52. The body portion 44 of the abutment portion 16 has been modified to accommodate the angle. As illustrated, the area of the body portion 44 to the left of the abutment screw 38 is much thicker, while the area of the body portion 44 to the right of the abutment screw 38 is much thinner.

The abutment portion 16 still has a screw bore 36 with a reduced circumference for engaging the conical sidewall 56 of the abutment portion 16, and a hex portion 34 for engaging the extension portion 14 (FIGS. 1 and 2). In this embodiment, the fifth threaded portion 52 may partially enter the screw bore 36 due to the large angular difference between them. FIG. 6 shows the abutment portion 16 of FIG. 5 rotated ninety degrees to illustrate a front view of the thirty degree angle abutment portion 16.

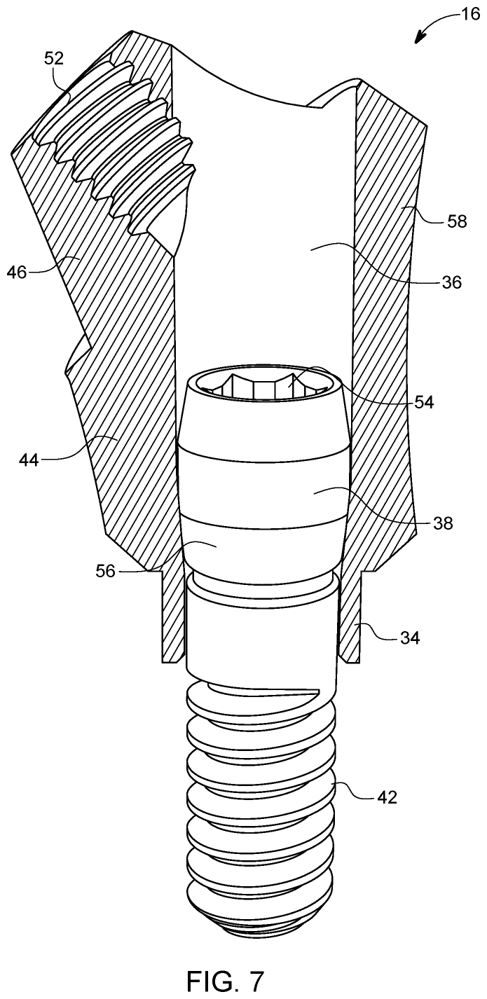

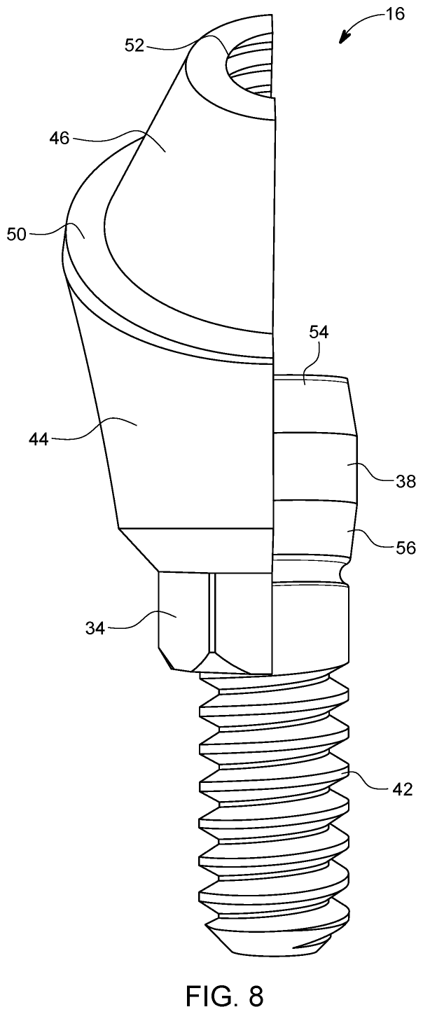

Referring to FIGS. 7 and 8, a forty-five degree angle multi-unit abutment portion 16 is shown. Referring to FIG. 7, in this embodiment, the abutment portion 16 still includes the screw bore 36 which is the same as the other embodiments for capturing and retaining the abutment screw 38 in the same manner. Since the prosthetic (not shown) in this embodiment will be mounted at a forty-five degree angle relative to the implant screw 12 (FIGS. 1 and 2), the mounting portion 46, seat area 50, and fifth threaded portion 52 must also be at a forty-five degree relative to the implant screw 12.

For this reason, the mounting portion 46 of the abutment portion 16 is almost completely on one side (left, as illustrated) of the abutment portion 16. Accordingly, the body portion 44 comprises an elongated sidewall portion 58 opposite the mounting portion 46, fifth threaded portion 52, and seat area 50, to account for the elongated distance created by the seat area 50. Also shown in this view, the fifth threaded portion 52, being at a forty-five degree angle to the screw bore 36, extends into the screw bore 36. The elongated side portion 58 allows the abutment screw 38 to extend through the screw bore 36 and be tightened into the extension portion 14 with the hex socket 54, such that the hex socket 54 is out of the way of the prosthetic screw (not shown) when inserted through the prosthetic (not shown) and tightened into the fifth threaded portion 52.

FIG. 8 illustrates the forty-five degree embodiment of the abutment portion 16 rotated ninety degrees to illustrate a front view of the forty-five degree angle abutment portion 16. The forty-five degree angle embodiment abutment portion 16 is useful when there is a greater distance between the anchoring point of the implant screw 12 (FIGS. 1 and 2) and the prosthetic implant site, such that the extension portion can extend farther, terminating at the abutment portion and prosthetic. In various additional embodiments, it is anticipated that a kit having a variety of abutment portions 16 may be prepared, with angles between zero and sixty degrees. This will enable a user to place implants in a variety of areas, selecting the appropriate angle abutment portion 16 relative to an implant screw 12 site.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claim.

What is claimed is:

1. A multi-unit abutment apparatus for placing a prosthetic tooth in the osseous bone of a dental implant patient remotely from an implant screw, the apparatus comprising:
an implant screw having a first threaded portion configured for engaging and anchoring in the osseous bone;
an elongated extension portion configured with a conical bottom portion for engaging the implant screw and having a socketed top;
an abutment portion having an anti-rotation portion configured to engage the socketed top of the elongated extension portion in a non-rotational arrangement;
the abutment portion further comprising a body portion having a screw bore in axial parallel with the elongated extension portion and the implant screw;
the abutment portion further comprising a mounting portion having a seat configured for seating the prosthetic tooth, and a fifth threaded portion configured to accept a prosthetic screw for mounting the prosthetic tooth to the abutment portion; and
wherein the fifth threaded portion is between zero and sixty degrees off-axis from the elongated extension portion.

2. The apparatus of claim 1 wherein the implant screw includes a first threaded portion for engaging the patient's osseous bone and a second threaded portion for engaging the extension portion.

3. The apparatus of claim 2 wherein the first threaded portion is opposite the second threaded portion.

4. The apparatus of claim 2 wherein the second threaded portion includes a non-threaded upper portion configured to engage the conical bottom portion of the extension portion.

5. The apparatus of claim 1 wherein the anti-rotation portion is a hex pattern and wherein the socketed top is a complimentary hex pattern.

6. The apparatus of claim 1 wherein the screw bore comprises a reduced conical circumference corresponding to a conical portion of an abutment screw configured to engage the extension portion.

7. The apparatus of claim 1 wherein the abutment portion comprises a mounting portion on which the prosthetic tooth seats.

8. The apparatus of claim 1 wherein the mounting portion has a variable conical surface.

9. The apparatus of claim 8 wherein the seat surrounds the variable conical surface.

10. The apparatus of claim 1 wherein the screw bore is configured such that an abutment screw engaging the extension portion clears a prosthetic screw engaging the prosthetic tooth and fifth threaded portion.

11. An extension apparatus for spanning a dental implant screw and a multi-unit abutment for placing one or more prosthetic teeth in the osseous bone of a dental implant patient remotely from one or more implant screws, the apparatus comprising:
an elongated extension member having a first end and a second end;
the first end comprising a first threaded portion configured for engaging and anchoring in a second threaded portion of the dental implant screw;
the first end further comprising a first conical portion adjacent the first threaded portion, wherein the first conical portion is configured such that it engages over its entirety a complimentary conical portion in the dental implant screw adjacent the second threaded portion;
the second end comprising a socketed top portion with a third threaded portion configured to receive a fourth threaded portion of a multi-unit abutment anchoring screw; and
the socketed top portion further comprising a polygonal configuration to prevent rotation of the multi-unit abutment relative to the elongated extension member.

12. The apparatus of claim 11, wherein the dental implant screw abuts the first end of the elongated extension portion when fully engaged thereto.

13. The apparatus of claim 11 wherein the multiunit abutment abuts the second end of the elongated extension portion when fully engaged thereto.

14. The apparatus of claim 11 wherein the multi-unit abutment anchoring screw has a screw head with a conical sidewall.

15. A multi-unit abutment kit apparatus, the apparatus comprising:
a plurality of implant screws, each having a first threaded portion;
a plurality of elongated extension portions, each configured with a conical bottom portion for engaging one of the implant screws and having a socketed top;
a plurality of abutment portions, each having an anti-rotation portion configured to engage the socketed top of the elongated extension portion in a non-rotational arrangement;
each of the abutment portions further comprising a body portion having a screw bore in axial parallel with the elongated extension portion and the implant screw;
each of the abutment portions further comprising a mounting portion having a seat configured for seating the prosthetic tooth, and a fifth threaded portion configured to accept a prosthetic screw for mounting the prosthetic tooth to the abutment portion; and
wherein the fifth threaded portion is between zero and sixty degrees off-axis from the elongated extension portion.

16. The apparatus of claim 15 wherein each of the implant screws includes a first threaded portion for engaging the patient's osseous bone and a second threaded portion for engaging the extension portion.

17. The apparatus of claim 16 wherein each of the first threaded portions is opposite the second threaded portion.

18. The apparatus of claim 16 wherein each of the second threaded portions includes a non-threaded upper portion configured to engage the conical bottom portion of the extension portion.

19. The apparatus of claim 15 wherein each of the anti-rotation portions is a hex pattern and wherein the socketed top is a complimentary hex pattern.

20. The apparatus of claim 15 wherein the screw bore comprises a reduced conical circumference corresponding to a conical portion of an abutment screw configured to engage the extension portion.
